(19) United States
(12) Patent Application Publication
(10) Pub. No.: US 2024/0396840 A1
(43) Pub. Date: Nov. 28, 2024

(54) TOE-BASED NETWORK INTERFACE DEVICE CAPABLE OF ASYNCHRONOUS PERFORMING TCP EVENT HANDLING AND TCP OPERATION PROCESSING, OPERATION METHOD THEREOF, AND SERVER DEVICE INCLUDING THE SAME

(71) Applicant: MangoBoost Inc., Seoul (KR)

(72) Inventors: Yujin Chung, Seoul (KR); Junehyuk Boo, Seoul (KR)

(21) Appl. No.: 18/673,331

(22) Filed: May 24, 2024

(30) Foreign Application Priority Data
May 26, 2023 (KR) 10-2023-0068674
Apr. 30, 2024 (KR) 10-2024-0058166

(51) Int. Cl. H04L 47/193; H04L 47/125

(52) U.S. Cl. CPC H04L 47/193; H04L 47/125

(57) ABSTRACT

A TOE based network interface device according to an example embodiment of the present disclosure includes: a first table configured to accumulate at least two TCP events sequentially for a first TCP connection, from a first time point to a second time point; and a TCP processing logic configured to perform a single TCP operation for the at least two TCP events after the second time point has elapsed.

### CROSS-REFERENCE TO RELATED APPLICATION(S)

This application claims benefit of priority to Korean Patent Application Nos. 10-2023-0068674, filed on May 26, 2023, and 10-2024-0058166, filed on Apr. 30, 2024, in the Korean Intellectual Property Office, the disclosures of which are incorporated herein by reference in their entirety.

### BACKGROUND

The present disclosure relates to a network interface, more specifically, relates to a network interface device based on a TCP/IP Offload Engine (TOE) capable of asynchronously performing a TCP event handling and a TCP operation processing, an operation method thereof, and a server device including the same.

The application of big data or artificial intelligence is expanding and the use of over-the-top (OTT) services becomes almost routine. As a result, there is an urgent need to improve the performance of various devices connected through the network, such as user terminals, web servers, web application servers (WAS), storage servers, and database servers, in terms of data processing volume and processing speed.

Specifically, network devices may require enormous system resources to perform data communication based on the Transmission Control Protocol/Internet Protocol (TCP/IP) Protocol in a high-speed network environment. For example, when a web server performs data communication with a large number of user terminals over a network, the web server's central processing unit (CPU) may experience a significant load to perform TCP/IP operations. This may cause performance degradation and communication delays throughout the web server.

Thus, various technologies have emerged to distribute the load of the CPU on network devices, among which the TCP/IP Offload Engine (TOE) technology is a technology that offloads the CPU load by implementing the transport layer and network layer, which were previously implemented in software in TCP/IP, as separate hardware (e.g., Network Interface Card). TOE technology to implement high-speed network environments requires efficient and flexible hardware or software design, such as high performance and multiple connection support.

### SUMMARY

The present disclosure is intended to provide a high-performance TOE-based network interface device capable of enhancing data processing efficiency by efficiently controlling and utilizing system resources in a high-speed network environment, an operation method thereof, and a server device including the same.

A network interface device according to an example embodiment of the present disclosure includes: a first table configured to accumulate at least two TCP events sequentially for a first TCP connection, from a first time point to a second time point; and a TCP processing logic configured to perform a single TCP operation for the at least two TCP events after the second time point has elapsed.

A server device according to an example embodiment of the present disclosure includes: a network interface device including a first table configured to accumulate at least two TCP events sequentially for a first TCP connection, from a first time point to a second time point, and a TCP processing logic configured to perform a first TCP operation for the at least two TCP events after the second time point has elapsed.

An operation method of a network interface device according to an example embodiment of the present disclosure, the method includes: accumulating a first TCP event through an N^{th} TCP event (wherein N is an integer greater than or equal to 2) sequentially received from a first time point to a second time point for a first TCP connection into a first entry of a first table of the network interface device by an event handler of the network interface device; and performing a TCP operation for the N^{th} TCP event after a second time point by a TCP processing logic of the network interface device.

According to an example embodiment of the present disclosure, a TOE-based network interface device, an operation method thereof, and a server device including the same, high performance TCP operation may be realized by performing a TCP event handling and a TCP operation processing asynchronously.

In addition, according to an example embodiment of the present disclosure, a TOE-based network interface device, an operation method thereof, and a server device including the same, high performance may be achieved by allowing a TCP processing logic to process at least two TCP events for the same TCP connection at once.

In addition, according to an example embodiment of the present disclosure, a TOE-based network interface device, an operation method thereof, and a server device including the same, high performance for processing of multiple TCP connections can be achieved because a stateless nature of a TCP processing logic and a round-robin scheduling enables independent processing of different TCP connections in a pipelined manner.

The effects of the exemplary embodiments of the present disclosure are not limited to those described above, and other effects not described may be clearly derived and understood by persons of ordinary skill in the art to which the exemplary embodiments of the present disclosure belong from the following description. In other words, unintended effects of implementing the exemplary embodiments of the present disclosure may also be derived from the exemplary embodiments of the present disclosure by persons of ordinary skill in the art.

### BRIEF DESCRIPTION OF THE DRAWINGS

FIG. 1 is a view schematically illustrating a server device according to an example embodiment of the present disclosure;

FIG. 2 is a view schematically illustrating a network interface device according to an example embodiment of the present disclosure;

FIGS. 3 through 7 are views sequentially illustrating processing operations of TCP events in a network interface device respectively according to an example embodiment of the present disclosure;

FIGS. 8A and 8B are views illustrating memories of a network interface device according to an example embodiment of the present disclosure; and

FIG. 9 is a table illustrating TCP parameters included in each entry of an event table and a TCB table, according to an example embodiment of the present disclosure.

### DETAILED DESCRIPTION

Hereinafter, with reference to the drawings, example embodiments of the present disclosure are described in detail to facilitate implementation by persons of ordinary skill in the art to which the disclosure belongs. However, the present disclosure may be implemented in many different forms and is not limited to the example embodiments described herein. In relation to the description of the drawings, the same or similar reference numerals may be used for identical or similar components. In addition, in the drawings and associated description, descriptions of well-known features and configurations may be omitted for clarity and brevity.

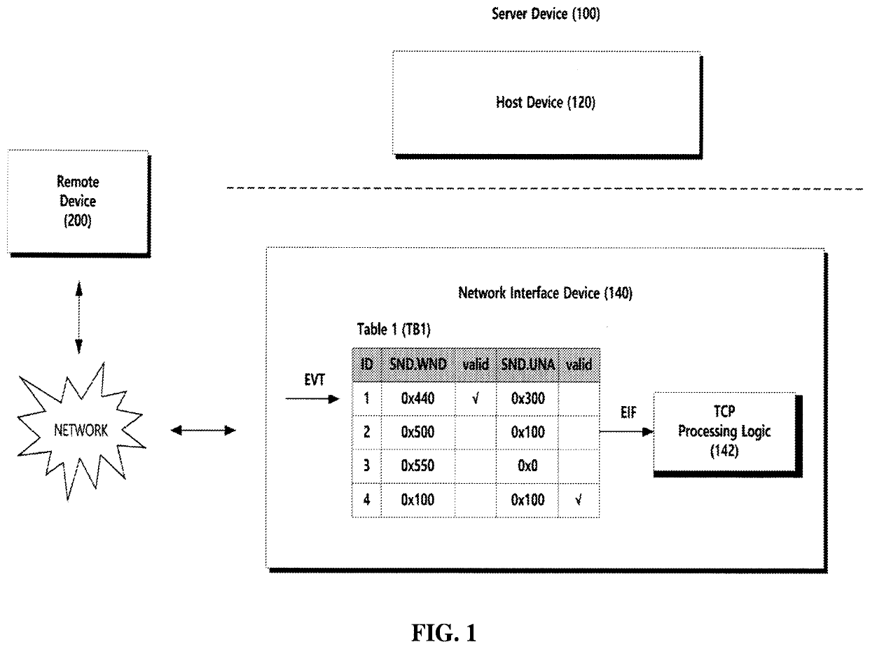

FIG. 1 is a view schematically illustrating a server device 100 according to an example embodiment of the present disclosure.

Referring to FIG. 1, according to an example embodiment of the present disclosure, a server device 100 and a remote device 200 may be connected in a TCP session over a network to perform communication. The TCP session may mean a communication path between the server device 100 and the remote device 200 that is connected through a network, which may be specified by an IP address and port number and identified by a flow ID. In the present disclosure, the TCP session may be understood as the same meaning as a TCP connection.

The server device 100 according to an example embodiment of the present disclosure may include a host device 120 for TCP communication and a TOE-based network interface device 140. The server device 100, the host device 120, or the network interface device 140 according to an example embodiment of the present disclosure may be provided or controlled in such a way that processing of a TCP event EVT and a TCP operation processing may be performed asynchronously, thereby improving the TCP processing speed while ensuring functionality of the TOE. Specifically, the network interface device 140 according to an example embodiment of the present disclosure may perform TCP operations in a lump for at least two TCP events EVT that accumulate sequentially.

The TCP events EVT that may occur on the network interface device 100 may include, for example, a reception of a user request, a reception of a TCP packet from the network, or a timeout. The user request may be a TCP packet that an application on the host device 120 intends to transmit to a remote device 200 or a TCP packet that an application intends to receive from the remote device 200.

For example, the former and the latter may be the user request “send( )” and “recv( )”. In the present disclosure, the “user request” may be understood in the same meaning as a “command,” an “event,” and a “function” as necessary. The timeout may occur when the network interface device 100 has not completely handled an acknowledgment (ACK) for data transmitted by the network interface device 100 until a certain amount of time has elapsed. For example, the network interface device 100 may cause the timeout based on the elapse of a retransmission timeout (RTO) time.

The network interface device 140 according to example embodiments of the present disclosure may include a first table TB1 and a TCP processing logic 142 capable of processing such TCP events. The first table TB1 may sequentially accumulate at least two TCP events EVT for any TCP connection, from a first time point to a second time point. FIG. 1 illustrates, but not limited to, an example where the accumulation of TCP events EVT is performed by way of updating the values of corresponding entry in the first table TB1.

Although not shown, the network interface device 140 may accumulate the TCP events EVT received sequentially from the first time point through an event handler by delivering the TCP events EVT to the first table TB1.

The first table TB1 may be a TCP event table. The first table TB1 may include, for each entry, an ID field, at least one TCP parameter field, and a valid bit field.

The ID field may store a flow ID of a TCP connection. Multiple TCP connections formed between the server device 100 and the remote device 200 may be identified by a unique flow ID, as described above. For convenience of description, ID1 through ID4 in the ID field of FIG. 1 refer to the first TCP connection ID1 through the fourth TCP connection ID4, respectively.

The TCP parameter field may store parameters that define a TCP event EVT. In the present disclosure, a “parameter” of a TCP parameter may be understood in the same meaning as a “variable” or a “pointer”.

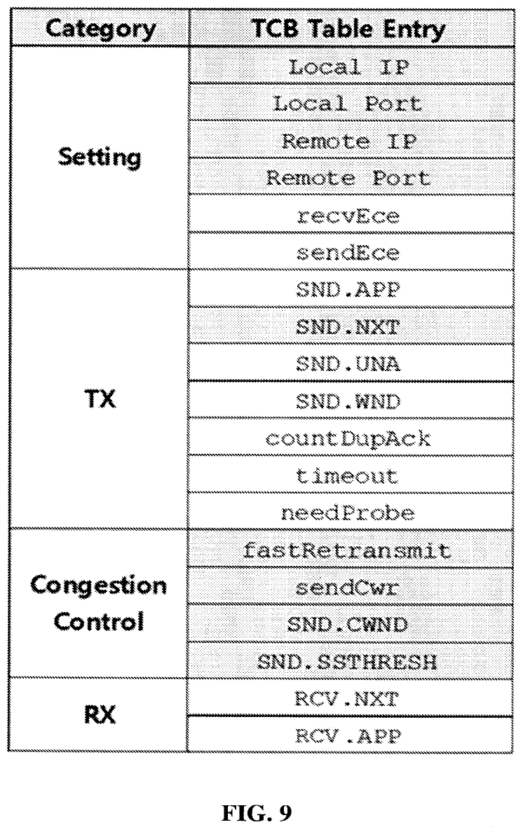

In the example of FIG. 1, the TCP parameter field may store “SND.WND” and “SND.UNA”. The “SND.WND” indicates the size of the send window, i.e., the size of data that the network interface device 140 may transmit at any time point for that TCP connection. The “SND.UNA” indicates the sequence number of the first unacknowledged data to be transmitted, i.e., the sequence number of the first data that the network interface device 140 has transmit but for which an ACK packet has not yet been received from the remote device 200. However, it is not limited thereto, and the TCP parameter field may further include at least one of “recvEce”, a “sendEce”, “SND.APP”, “countDupAck”, “timeout”, and “needProbe”. The meaning of each TCP parameter field and examples of more TCP parameters that may be added to the TCP parameter field will be described in FIG. 9.

In the example of FIG. 1, the “SND.WND” and the “SND.UNA” for the accumulated TCP events EVT to the present for the first TCP connection ID1 are “0x440” and “0x300”, respectively. For example, the “SND.WND” of “0x320” at a first time point for a first TCP event EVT may be stored in the first table TB1 with a value of current “0x440” at a second time point due to the occurrence of at least one TCP event EVT, such as a “send( )” or TCP packet reception, for the first TCP connection ID1.

Referring again to FIG. 1, the valid bit field of the first table TB1 may store a valid bit indicating whether the corresponding TCP parameter field has been updated for the first TCP connection ID1. Setting of the valid bit may be performed by the event handler.

FIG. 1 illustrates an example of setting the valid bit for the “SND.WND” of the first TCP connection ID1. In this case, the valid bit may be set or not by having a value of “1” or “0”. On the other hand, in FIG. 1, the valid bit for the “SND.UND” of the first TCP connection ID1 has an unset state. This may indicate that at any time point, after the TCP processing logic 142 has processed a TCP operation for the first TCP connection ID1, the occurrence of a new TCP event EVT causes the “SND.WND” of the first TCP connection ID1 to be updated and the “SND.UND” of the first TCP connection ID1 to retain its existing value.

The TCP processing logic 142 of the network interface device 140 performs one TCP operation for the at least two TCP events EVT after the elapse of the second time point. For example, the network interface device 140 may perform TCP operations for the last stored TCP event EVT in the first table TB1 among the at least two TCP events EVT, i.e., the last occurred TCP event. For example, when three TCP events EVT occurred for the first TCP connection ID1 from the first time point to the second time point, the TCP processing logic 142 may perform TCP operations after the second time point for the three TCP events EVT that occurred. As described above, the third TCP event may be an accumulation of three TCP events, including the two TCP events that occurred earlier.

The TCP processing logic 142 may perform reliable TCP communication between the server device 100 and the remote device 200 through algorithms such as, for example, a flow control, a congestion control, and the like. For example, the TCP processing logic 142 may perform TCP operations to determine data to be transmitted, handle ACKs for received data, perform retransmission, and transmit a probe packet.

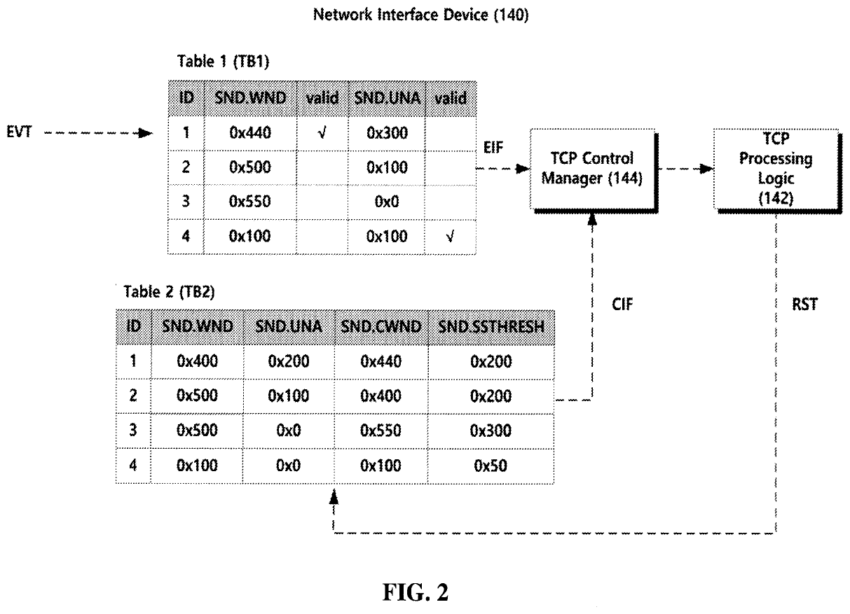

FIG. 2 is a view schematically illustrating a network interface device 140 according to an example embodiment of the present disclosure.

Referring to FIG. 2, the network interface device 140 according to an example embodiment of the present disclosure may further include a TCP control manager 144 and a second table TB2, along with the first table TB1 and the TCP processing logic 142. The first table TB1, the TCP processing logic 142, the TCP control manager 144, and the second table TB2 may be included in a TCP controller (not shown) that may be implemented on a single chip.

The TCP processing logic 142, according to an example embodiment of the present disclosure, may not separately store a state information required for TCP operations. In other words, the TCP processing logic 142 may perform corresponding TCP operations when it receives information, parameters, or data required for TCP operations from the TCP control manager 144.

The TCP control manager 144 may schedule and deliver an event information EIF or a control information CIF required for processing a TCP connection to the TCP processing logic 142. The TCP control manager 144 may receive the event information EIF from the first table TB1 and the control information CIF from the second table TB2. The control information CIF may be delivered in the form of a transmission control block TCB.

The second table TB2 may store the control information CIF and may store a TCP processing result RST of the TCP processing logic 142 for the control information CIF. The second table TB2 may be a TCB table. The control information CIF delivered from the second table TB2 to the TCP control manager 144 may be updated as the TCP processing result RST after the operation processing of the TCP processing logic 142 for the control information CIF.

The TCP processing result RST may also be delivered to the second table TB2 in the form of a transmit control block. The TCP processing result RST may be stored in the second table TB2 and used as the control information CIF when the TCP processing logic 142 performs the next TCP operation for the corresponding TCP connection.

FIG. 2 illustrates that the second table TB2 may include “SND.CWND” and “SND.SSTHRESH” in addition to the “SND.WND” and the “SND.UNA” of the first table TB1 for the first TCP connection ID1 through the fourth TCP connection ID4. The “SND.CWND” indicates the size of the congestion control window for the corresponding TCP connection, and the “SND.SSTHRESH” indicates the threshold point for a slow start, one of the congestion control algorithms.

The TCP control manager 144 may transmit the event information EIF and the control information CIF to the TCP processing logic 142 in a round-robin method within the TCP processing logic 142. For example, the TCP control manager 144 may deliver the control information CIF for the first TCP connection ID1 to the TCP processing logic 142, and then deliver the control information CIF for the second TCP connection ID2, and then deliver the control information CIF for the third TCP connection ID3 and the fourth TCP connection ID4 sequentially. The TCP control manager 144 may deliver the event information EIF to the TCP processing logic 142 in the same order. For example, the TCP control manager 144 may deliver the event information EIF for the first TCP connection ID1, and then deliver the event information EIF for the second TCP connection ID2, and then deliver the event information EIF for the third TCP connection ID3 and the fourth TCP connection ID4 sequentially. By adopting the round-robin method, the server device 100 according to an example embodiment of the present disclosure may guarantee a maximum processing latency for each TCP connection.

As such, the network interface device 140 according to an example embodiment of the present disclosure may achieve high performance by allowing the TCP processing logic 142 to process the TCP events EVT accumulated from the first time point to the second time point for a single TCP connection at once. For example, when eight transfer requests having a data size of 100 bytes have occurred for the first TCP connection ID1 from a transfer request with a sequence number “1000” at the first time point to the second time point, the TCP processing logic 142 may process operations only for one transfer request having a sequence number of “1800”.

In addition, the network interface device 140 according to an example embodiment of the present disclosure may achieve high performance for processing of multiple TCP connections because the stateless nature of the TCP processing logic 142 and the round-robin scheduling allows independent processing for different TCP connections in a pipelined manner.

The TCP processing logic 142 according to an example embodiment of the present disclosure may perform the entire processing of multiple TCP connections in a pipelined manner. Thus, the TCP processing logic 142 may simultaneously perform TCP operations on the TCP event EVT of the first TCP connection ID1 input to the first table TB1 at the third time point and the TCP event EVT of the second TCP connection ID2 input to the first table TB1 at the fourth time point. In the present disclosure, the meaning of “simultaneous” does not only mean that the processing of the TCP event EVT of the first TCP connection ID1 and the TCP event EVT of the second TCP connection ID2 is exactly the same, i.e., the start and end of the TCP operation are exactly the same. Even when the processing of the TCP event EVT of the first TCP connection ID1 is started before the processing of the TCP event EVT of the second TCP connection ID2 is completed, the two operations are also considered to be performed simultaneously.

Furthermore, the network interface device 140 according to an example embodiment of the present disclosure may not suffer from structural hazards such as memory contention due to the stateless nature of the TCP processing logic 142, and may be capable of multiple processing for multiple TCP connections without data hazards for the same TCP connection through the round-robin scheduling.

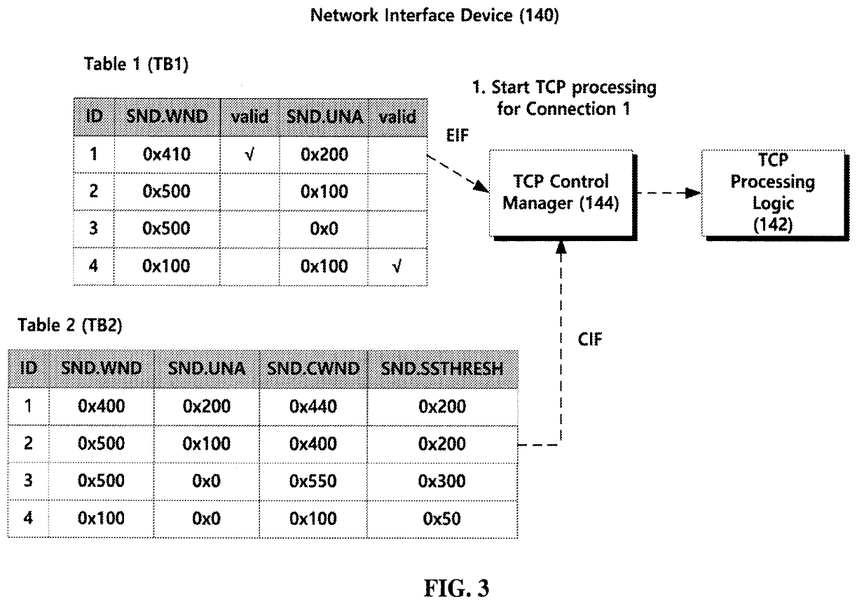

FIGS. 3 through 7 are views sequentially illustrating processing operations of the TCP events EVT in the network interface device 140 respectively according to an example embodiment of the present disclosure.

Referring first to FIG. 3, the TCP control manager 144 of the network interface device 140 according to an example embodiment of the present disclosure may deliver the event information EIF and the control information CIF for the first TCP connection ID1 to the TCP processing logic 142. The event information EIF and the control information CIF may be delivered from the first entries of the first table TB1 and the second table TB2, respectively.

In the first entry of the second table TB2, “SND.WND”, “SND.UNA”, “SND.CWND”, and “SND.SSTHRESH” are stored as “0x400”, “0x200”, “0x440”, and “0x200”, respectively, which may be the most recent TCP processing result RST for the first TCP connection ID1. Since the valid bit for the “SND.WND” in the first entry of the first table TB1 is set, it may be confirmed that the TCP event EVT for the “SND.WND” of the first TCP connection ID1 occurred after the most recent TCP processing result RST for the first TCP connection ID1 was generated. On the other hand, the valid bit for the “SND.UNA” of the first TCP connection ID1 is not set, it may be understood that the corresponding value has not been updated after the most recent TCP processing result RST for the first TCP connection ID1 was generated.

The valid bit for the first TCP connection ID1 may be reset when the event information EIF for the first TCP connection ID1 is delivered to the TCP processing logic 142 by the TCP control manager 144. The same is true for the valid bits for other TCP connections.

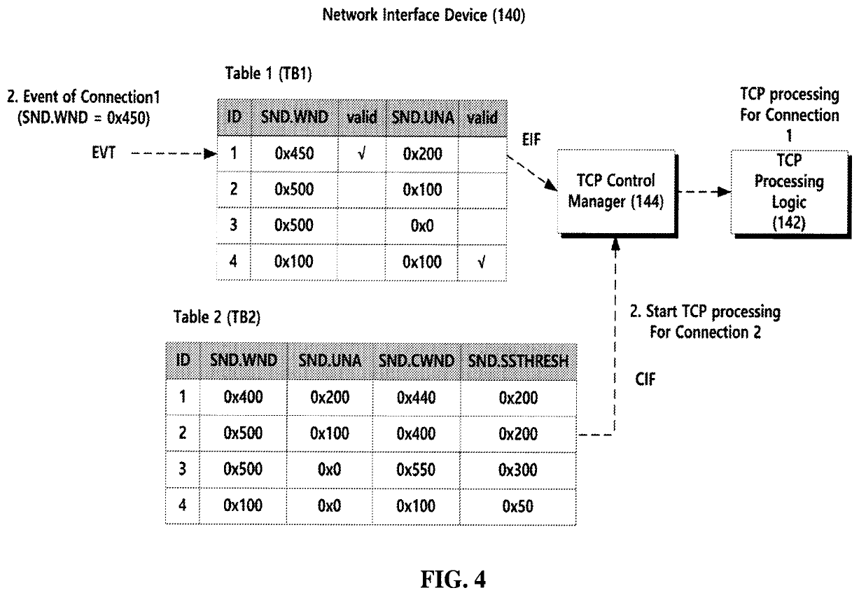

Next, referring to FIG. 4, while processing for the first TCP connection ID1 is in progress in the TCP processing logic 142, a new TCP event EVT may occur where “SND.WND” for the first TCP connection ID1 is “0x450”. In this case, the value of the TCP parameter field for the “SND.WND” of the first entry of the first table TB1 may be changed from “0x410” to “0x450”, and the corresponding valid bits may remain a set state.

As such, the TCP processing logic 142 according to an example embodiment of the present disclosure may perform a TCP operation for the N^{th} TCP event EVT of the first TCP connection ID1 and, simultaneously, update the (N+1)^{th} TCP event EVT of the first TCP connection ID1 to the first table TB1 through the event handler. Meanwhile, the TCP control manager 144 may deliver the event information EIF and the control information CIF for the second TCP connection ID2 to the TCP processing logic 142 according to the round-robin scheduling, and the TCP processing logic 142 may start processing the second TCP connection ID2 independently of the processing for the first TCP connection ID1.

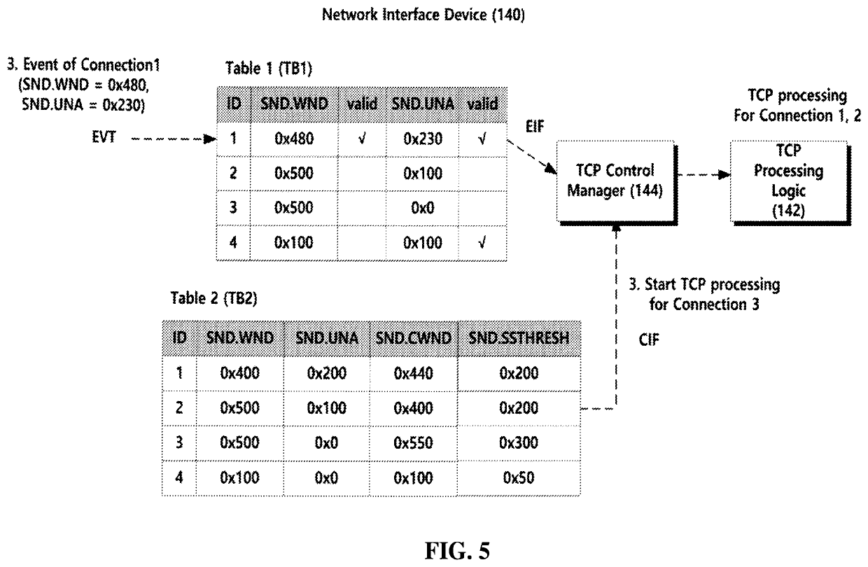

Next, referring to FIG. 5, while processing for the first TCP connection ID1 and the second TCP connection ID2 is in progress in the TCP processing logic 142, a new TCP event EVT may occur where “SND.WND” and “SND.UNA” for the first TCP connection ID1 are “0x480” and “0x230” respectively. Thus, in the first entry of the first table TB1, the value of the TCP parameter field for the “SND.WND” may change from “0x450” to “0x480” and the valid bit thereof may remain a set state. Similarly, in the first entry of the first table TB1, the value of the TCP parameter field for the “SND.UNA” may be changed from “0x200” to “0x230” and the valid bit thereof may be changed to a set state.

Meanwhile, the TCP control manager 144 may deliver the event information EIF and the control information CIF for the third TCP connection ID3 to the TCP processing logic 142 according to the round-robin scheduling, and the TCP processing logic 142 may start processing the third TCP connection ID3 independently of the processing for the first TCP connection ID1 and the second TCP connection ID2.

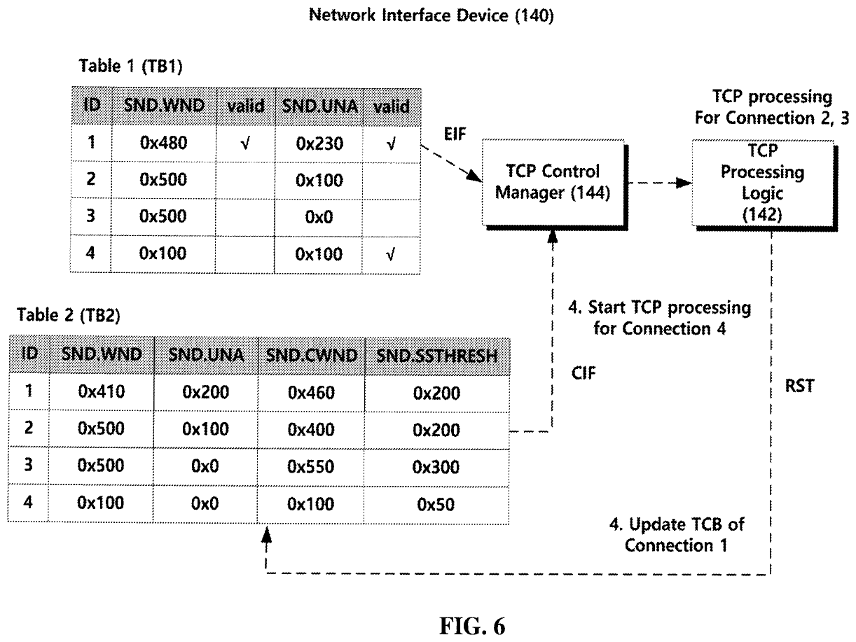

Next, referring to FIG. 6, the TCP processing logic 142 may complete processing for the first TCP connection ID1 and update the first entry in the second table TB2 as the TCP processing result RST.

In the case of FIG. 6, the first entry in the second table TB2 is updated as the TCP processing result RST for the first TCP connection ID1 output by the TCP processing logic 142. In this case, the values of “SND.WND” and “SND.UNA” updated in the first entry of the second table TB2 may be “0x410” and “0x200” because the corresponding TCP processing result RST is for the event information EIF corresponding to the first entry of the first table TB1 shown in FIG. 3. And, the “SND.CWND” among the first entry of the second table TB2 may be updated from the existing “0x410” to “0x460” as the result of the operation of the TCP congestion control algorithm in the TCP processing logic 142.

Meanwhile, the TCP processing logic 142 may start processing the fourth TCP connection ID4 independently of the second TCP connection ID2 and the third TCP connection ID3. As the event information EIF for the fourth TCP connection ID4 is delivered to the TCP processing logic 142 through the TCP control manager 144 for processing, all of the valid bits of the fourth entry in the first table TB1 may be reset.

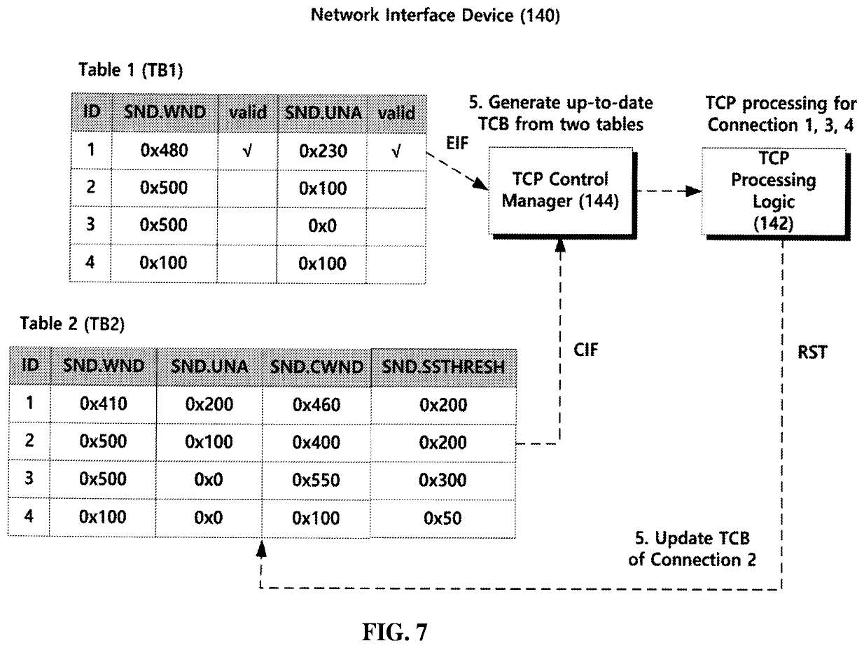

Next, referring to FIG. 7, TCP processing for the first TCP connection ID1 may again be performed according to the round-robin scheduling. That is, the value of the first entry in the first table TB1 as the event information EIF and the value of the first entry in the second table TB2 as the control information CIF may be scheduled by the TCP control manager 144 and delivered to the TCP processing logic 142.

The TCP processing logic 142 may deliver the TCP processing result RST for the second TCP connection ID2 that has completed processing to the second table TB2, and the second entry of the second table TB2 may be updated as the TCP processing result RST. In this case, since the TCP event EVT did not occur before the TCP processing for the second TCP connection ID2 was performed in FIG. 4, i.e., all the valid bits of the second entry of the first table TB1 were not set, the TCP processing result RST in FIG. 7 may be the same as the existing values of the second entry of the second table TB2. Thus, the values of each field of the second entry of the second table TB2 may not be changed by the update operation in FIG. 7. However, it is not limited thereto, and depending on the communication environment, the TCP processing result RST may be different regardless of whether a TCP event EVT occurs or not.

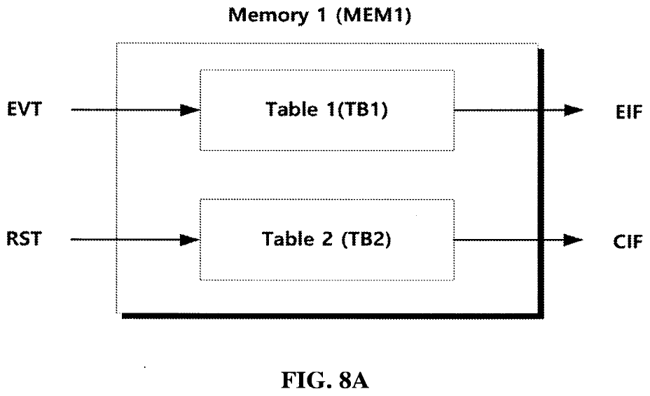

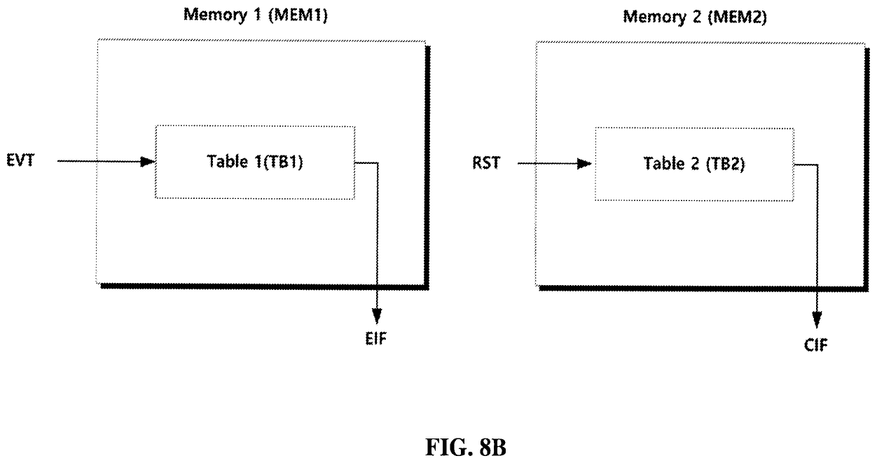

FIGS. 8A and 8B are views illustrating memories MEM1 and MEM2 of the network interface device 140 according to an example embodiment of the present disclosure.

Referring first to FIG. 8A, the network interface device 140 of FIG. 1 or FIG. 2 may include a first memory MEM1. The first memory MEM1 may be implemented as a static random access memory (SRAM). Both the first table TB1 and the second table TB2 may be included in the first memory MEM1. In this case, the first memory MEM1 may have dual ports or more input and output ports, such that access to the first table TB1 and access to the second table TB2 may be performed independently of each other. Thus, malfunctions such as conflicts of at least two of the TCP events EVT, the TCP processing results RST, the event information EIF, and the control information CIF may be prevented.

Next, referring to FIG. 8B, the network interface device 140 of FIG. 1 or FIG. 2 may include the first memory MEM1 containing the first table TB1 and the second memory MEM2 containing the second table TB2. By including the first table TB1 and the second table TB2 in different memories, malfunctions may be prevented, as shown in FIG. 8A.

Both the first memory MEM1 and the second memory MEM2 may be implemented as SRAM. However, it is not limited thereto. Either the first memory MEM1 of FIG. 8A or the first memory MEM1 and the second memory MEM2 of FIG. 8B may be implemented as a dynamic random access memory (DRAM).

FIG. 9 is a table illustrating TCP parameters included in each entry of an event table and a TCB table, according to an example embodiment of the present disclosure.

Referring now to FIGS. 1, 2, and 9, as described above, the first table TB1 may be an event table and the second table TB2 may be a TCB table, according to an example embodiment of the present disclosure. FIG. 2 illustrates an example wherein each entry in the first table TB1 includes the TCP parameter fields “SND.WND” and “SND.UNA” for the corresponding TCP connection and the valid bit field for each TCP parameter field, and each entry in the second table TB2 includes the TCP parameter fields “SND.WND”, “SND.UNA”, “SND.CWND”, and “SND.SSTHRESH” for the corresponding TCP connection as the TCP parameter fields. However, this is only for the convenience of description. The first table TB1 and second table TB2 according to an example embodiment of the present disclosure may further include various additional TCP parameters, as shown in FIG. 9.

For example, in relation to setting up a TCP connection, each entry in the first table TB1 or the second table TB2 according to an example embodiment of the present disclosure may include “Local IP” and “Local Port” representing the IP and port number of the network interface device 140, “Remote IP” and “Remote Port” representing the IP and port number of the remote device 200, and “recvEce” and “sendEce” for explicit congestion notification. In relation to TCP transmission, each entry of the first table TB1 or the second table TB2 according to an example embodiment of the present disclosure may include, in addition to the “SND.WND” and “SND.UNA”, “SND.APP” indicating the sequence number of data that the application on the host device 120 intends to send next, “SND.NXT” indicating the sequence number of the data that the network interface device 140 intends to send next, “countDupAck” indicating the number of duplicate ACKs, “timeout” indicating the occurrence of a retransmission timeout, and “needProbe” indicating whether a probe packet is necessary.

In relation to congestion control, each entry of the first table TB1 or the second table TB2 according to an example embodiment of the present disclosure may include, in addition to the “SND.CWND” and “SND.SSTHRESH”, “fastRetransmit” indicating whether fast retransmission is required and “sendCwr” indicating a reduction of the size of the transmission window. In relation to TCP reception, each entry of the first table TB1 or the second table TB2 according to an example embodiment of the present disclosure may include “RCV.NXT” indicating the first byte of the reception window and “RCV.APP” indicating the sequence number of data that the application on the host device 120 intends to receive next.

The TCP parameters may be provided in 64-bit, 32-bit, or Boolean type.

According to an example embodiment of the present disclosure, some TCP parameters may be included in the second table TB2 but not in the first table TB1. For example, TCP parameters that are not updated by the TCP events EVT may not be included in the first table TB1. For example, among the TCP parameters of FIG. 9, “Local IP” and “Local Port” or parameters related to congestion control may not be included in the first table TB1.

As such, the network interface device 140, the method of operation thereof, and the server device 100 including the same, according to an example embodiment of the present disclosure, may save memory space for storing the TCP events EVT and resources for processing the TCP events EVT by varying whether to store in the first table TB1 according to the nature of the TCP parameters.

Although not shown, the network interface device 140 according to an example embodiment of the present disclosure may further include a TCP controller configured to control TCP operations, a packet generator configured to generate TCP packets for transmission to the network, a receive parser configured to parse TCP packets received from the network, and a timer. In this time, the TCP controller may include In addition, the network interface device 140 according to an example embodiment of the present disclosure may further include separate modules for supporting other network protocols other than TCP/IP, such as Internet Control Message Protocol (ICMP), Address Resolution Protocol (ARP), and the like, and may perform link layer routing, and the like, through such processing modules.

According to example embodiments of the present disclosure, a network interface device may include a first table configured to accumulate at least two TCP events sequentially for a first TCP connection, from a first time point to a second time point, and a TCP processing logic configured to perform a single TCP operation for the at least two TCP events after the second time point has elapsed.

According to example embodiments of the present disclosure, the at least two TCP events may be sequentially updated to a first entry of the first table.

According to example embodiments of the present disclosure, the first entry may include a valid bit field configured to store a valid bit indicating whether the corresponding TCP event among the at least two TCP events has been updated.

According to example embodiments of the present disclosure, the valid bit may be reset when an event information for the at least two TCP events is delivered to the TCP processing logic.

According to example embodiments of the present disclosure, the TCP processing logic may be configured to receive and process a last occurring TCP event among the at least two TCP events from the first table.

According to example embodiments of the present disclosure, the network interface device may further include a second table configured to store a TCP processing result for the at least two TCP events of the TCP processing logic.

According to example embodiments of the present disclosure, the network interface device may further include a first memory including the first table and the second table accessed by input/output ports that are different from each other.

According to example embodiments of the present disclosure, the network interface device may further include a first memory including the first table, and a second memory including the second table.

According to example embodiments of the present disclosure, the second table may include more types of TCP parameter fields than the first table.

According to example embodiments of the present disclosure, the network interface device may further include a TCP control manager configured to schedule an event information of the first table and a control information of the second table and deliver the event information and the control information to the TCP processing logic.

According to example embodiments of the present disclosure, the control information may be delivered to the TCP control manager in the form of a transmission control block.

According to example embodiments of the present disclosure, the TCP processing logic may be configured to perform TCP operations for a TCP event of the first TCP connection input at a third time point and a TCP event of a second TCP connection input at a fourth time point simultaneously.

According to example embodiments of the present disclosure, a network interface device may include a first table configured to accumulate at least two TCP events sequentially for a first TCP connection, from a first time point to a second time point, and a TCP processing logic configured to perform a single TCP operation for the at least two TCP events after the second time point has elapsed.

According to example embodiments of the present disclosure, an operation method of a network interface device may include accumulating a first TCP event through an N^{th} TCP event (wherein N is an integer greater than or equal to 2) sequentially received from a first time point to a second time point for a first TCP connection into a first entry of a first table of the network interface device by an event handler of the network interface device, and performing a TCP operation for the N^{th} TCP event after the second time point by a TCP processing logic of the network interface device.

According to example embodiments of the present disclosure, the method may further include omitting a TCP operation for a TCP event received prior to the N^{th} TCP event among any of the first TCP event through the N^{th} TCP event by the TCP processing logic.

According to example embodiments of the present disclosure, the method may further include delivering the result of a TCP operation for the N^{th} TCP event to a first entry of a second table of the network interface device by the TCP processing logic.

According to example embodiments of the present disclosure, the sequentially accumulating the first through the N^{th} TCP events to the first entry may include setting a valid bit indicating whether the corresponding TCP event among the first through the N^{th} TCP events has been updated on a valid bit field of the first entry by the event handler.

According to example embodiments of the present disclosure, the performing a TCP operation for the N^{th} TCP event by the TCP processing logic may include delivering the N^{th} TCP event stored in the first table and a transmission control block stored in a second table of the network interface device to the TCP processing logic by a TCP control manager of the network interface device, applying a TCP algorithm for the N^{th} TCP event based on the N^{th} TCP event and the transmission control block by the TCP processing logic, and updating a transmission control block stored in the second table as the result of applying the TCP algorithm for the N^{th} TCP event by the TCP processing logic.

According to example embodiments of the present disclosure, the method may further include performing a TCP operation for a TCP event of a second TCP connection simultaneously by the TCP processing logic, when performing a TCP operation for the N^{th} TCP event.

According to example embodiments of the present disclosure, the method may further include updating an (N+1)^{th} TCP event for the first TCP connection to the first entry by the event handler simultaneously with performing a TCP operation for the N^{th} TCP event for the first TCP connection by the TCP processing logic.

The various embodiments and terms used herein are not intended to limit the technical features described herein to specific embodiments and should be understood to include various modifications, equivalents, or substitutes of the example embodiments. For example, an element expressed in a singular should be understood as a concept including a plurality of elements unless the context clearly refers only the singular. It should be understood that the term ‘and/or’ as used herein is intended to encompass any and all possible combinations of one or more of the enumerated items. As used in the present disclosure, the terms such as ‘comprise(s)’, ‘include(s)’ ‘have/has’, ‘configured of’, etc. are only intended to designate that the features, components, parts, or combinations thereof described in the present disclosure exist, and the use of these terms is not intended to exclude the possibility of the presence or addition of one or more other features, components, parts, or combinations thereof. In the present disclosure, each of the phrases such as “A or B”, “at least one of A and B”, “at least one of A or B”, “A, B or C”, “at least one of A, B and C”, and “at least one of A, B, or C” may include any one of the items enumerated together in a corresponding one of the phrases, or all possible combinations thereof. Terms such as “the first”, “the second”, or “first”, or “second” may be used simply to distinguish a corresponding component from another corresponding component, and do not limit the corresponding components in view of other aspect (e.g., importance or order).

The term “unit”, “block” or “module” used in various embodiments of the present disclosure may include a unit implemented in hardware, software, or firmware, or any combination thereof, and be used interchangeably with terms such as e.g., logic, logic block, part, component, or circuitry, for example. The unit, block or module may be a minimum unit or a part of the integrally configured component or the component that performs one or more functions. For example, according to an example embodiment, the unit, block or module may be implemented in the form of an ASIC or a FPGA.

The term “in case ˜” used in various embodiments of the present disclosure, may be construed to refer, for example, to “when ˜”, or “in response to determining ˜” or “in response to detecting ˜”, depending on the context. Similarly, the term “when it is determined that ˜” or “when it is detected that ˜” may be interpreted to refer, for example, to “upon determining ˜” or “in response to determining ˜”, or “upon detecting ˜” or “in response to detecting ˜”, depending on the context.

The program executed by the TOE-based network interface device 140 and the server device 100 described herein may be implemented as a hardware component, a software component, and/or a combination of the hardware component and the software component. The program may be executed by any system capable of executing computer readable instructions.

Software may include a computer program, codes, instructions, or a combination of one or more of these, and may configure a processing unit to perform operations as desired or command the processing unit independently or in combination (collectively). The software may be implemented as a computer program including instructions stored in a computer-readable storage medium. The computer-readable storage medium may include, for example, a magnetic storage medium (e.g., read-only memory (ROM), random-access memory (RAM), floppy disk, hard disk, and so on), an optically readable medium (e.g., CD-ROM, digital versatile disc (DVD), or the like) and so on. The computer-readable storage medium may be distributed among network-connected computer systems, so that the computer-readable code may be stored and executed in a distributed manner. The computer program may be distributed (e.g., downloaded or uploaded) by online, either via an application store (e.g. Play Store™) or directly between two user devices (e.g., smartphones). In the case of online distribution, at least a part of the computer program product may be temporarily stored or temporarily generated in a machine-readable storage medium such as a memory of a server of a manufacturer, a server of an application store, or a relay server. According to various embodiments, each component (e.g., module or program) of the above-described components may include a singular or a plurality of entities, and some of the plurality of entities may be separated and placed into other components. According to various embodiments, one or more components or operations among the above-described corresponding components may be omitted, or one or more other components or operations may be added thereto. Alternatively or additionally, a plurality of components (e.g., a module or a program) may be integrated into one component. In this case, the integrated component may perform one or more functions of each component of the plurality of components identically or similarly to those performed by the corresponding component among the plurality of components prior to the integration. According to various embodiments, operations performed by a module, program, or other component may be executed sequentially, in parallel, repeatedly or heuristically, or one or more of the operations may be executed in a different order or omitted, or one or more other operations may be added thereto.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the example embodiment(s) described herein may be used in conjunction with any other example embodiment(s) described herein.

What is claimed is:

1. A network interface device comprising:
a first table configured to accumulate at least two TCP events sequentially for a first TCP connection, from a first time point to a second time point; and
a TCP processing logic configured to perform a single TCP operation for the at least two TCP events after the second time point has elapsed.

2. The network interface device of claim 1, wherein the at least two TCP events is sequentially updated to a first entry of the first table.

3. The network interface device of claim 2, wherein the first entry comprises a valid bit field configured to store a valid bit indicating whether the corresponding TCP event among the at least two TCP events has been updated.

4. The network interface device of claim 3, wherein the valid bit is reset when an event information for the at least two TCP events is delivered to the TCP processing logic.

5. The network interface device of claim 1, wherein the TCP processing logic is configured to receive and process a last occurring TCP event among the at least two TCP events from the first table.

6. The network interface device of claim 1, further comprising:
a second table configured to store a TCP processing result for the at least two TCP events of the TCP processing logic.

7. The network interface device of claim 6, further comprising:
a first memory including the first table and the second table accessed by input/output ports that are different from each other.

8. The network interface device of claim 6, further comprising:
a first memory including the first table; and
a second memory including the second table.

9. The network interface device of claim 6, wherein the second table comprises more types of TCP parameter fields than the first table.

10. The network interface device of claim 6, further comprising:
a TCP control manager configured to schedule an event information of the first table and a control information of the second table and deliver the event information and the control information to the TCP processing logic.

11. The network interface device of claim 10, wherein the control information is delivered to the TCP control manager in the form of a transmission control block.

12. The network interface device of claim 1, wherein the TCP processing logic is configured to perform TCP operations for a TCP event of the first TCP connection input at a third time point and a TCP event of a second TCP connection input at a fourth time point simultaneously.

13. A server device comprising the network interface device of claim 1.

14. An operation method of a network interface device, the method comprising:
accumulating a first TCP event through an N^{th} TCP event (wherein N is an integer greater than or equal to 2) sequentially received from a first time point to a second time point for a first TCP connection into a first entry of a first table of the network interface device by an event handler of the network interface device; and
performing a TCP operation for the N^{th} TCP event after the second time point by a TCP processing logic of the network interface device.

15. The method of claim 14, further comprising:
omitting a TCP operation for a TCP event received prior to the N^{th} TCP event among any of the first TCP event through the N^{th} TCP event by the TCP processing logic.

16. The method of claim 14, further comprising:
delivering the result of a TCP operation for the N^{th} TCP event to a first entry of a second table of the network interface device by the TCP processing logic.

17. The method of claim 14, wherein,
the sequentially accumulating the first through the N^{th} TCP events to the first entry comprises,
setting a valid bit indicating whether the corresponding TCP event among the first through the N^{th} TCP events has been updated on a valid bit field of the first entry by the event handler.

18. The method of claim 14, wherein,
the performing a TCP operation for the N^{th} TCP event by the TCP processing logic comprises:
delivering the N^{th} TCP event stored in the first table and a transmission control block stored in a second table of the network interface device to the TCP processing logic by a TCP control manager of the network interface device;
applying a TCP algorithm for the N^{th} TCP event based on the N^{th} TCP event and the transmission control block by the TCP processing logic; and
updating a transmission control block stored in the second table as the result of applying the TCP algorithm for the N^{th} TCP event by the TCP processing logic.

19. The method of claim 14, further comprising:
performing a TCP operation for a TCP event of a second TCP connection simultaneously by the TCP processing logic, when performing a TCP operation for the N^{th} TCP event.

20. The method of claim 14, further comprising:
updating an (N+1)^{th} TCP event for the first TCP connection to the first entry by the event handler simultaneously with performing a TCP operation for the N^{th} TCP event for the first TCP connection by the TCP processing logic.
